(19) United States
(12) Patent Application Publication
(10) Pub. No.: US 2004/0129092 A1
(43) Pub. Date: Jul. 8, 2004

(54) Device for measuring in or on flexible hose-type pipes

(76) Inventor: Klaus Dietzel, Beerwalde/Lobichau (DE)

Correspondence Address: COOK, ALEX, MCFARRON, MANZO, CUMMINGS & MEHLER LTD, SUITE 2850, 200 WEST ADAMS STREET, CHICAGO, IL, 60606, US

(21) Appl. No.: 10/469,475

(22) PCT Filed: Feb. 23, 2002
(86) PCT No.: PCT/EP02/01921

(30) Foreign Application Priority Data
Feb. 28, 2001 (DE) 201 03 434.4

(51) Int. Cl. G01M 19/00

(52) U.S. Cl. 73/865.9; 73/866.1

(57) ABSTRACT

In a device for measuring pressures, temperatures, pulses, strains and other values in and of hose lines with a fitting during operation, the hose line (1) or the fitting has at least one measuring unit (6) which comprises at least one sensor (8) for each measured value, a transponder (13) and an antenna (10) for wireless data transmission to an external evaluating unit.

The invention relates to a device for measuring pressures, temperatures, pulses, strains and other values in and on hose lines during operation, above all in the case of hose lines which are subjected to great stresses of very different kinds and/or the unexpected failure of which can have serious consequences.

At present, no cost-effective devices are known, which can be used in large numbers in practice and with which the stress of hose lines can be measured, evaluated and recorded during operation. The various stresses, in particular in areas of difficult access and dangerous areas, to which such a hose line is subjected during its operating time are therefore not really known. Consequently, it is possible only to guess when a hose line is too old or overloaded and has to be replaced, which then frequently takes place either too late, with consequences which are often serious, or too soon, and therefore unnecessarily, which is uneconomical.

The invention is therefore based on the problem of providing a device for measuring values in and on hose lines during operation, which can be manufactured cost-effectively and used in most hose lines.

According to the invention, this problem is solved by virtue of the fact that the hose line has at least one measuring unit connected to the hose wall and which has at least one sensor for each value to be measured, a transponder and an antenna for wireless data transmission to an external evaluating unit. Above all, values which affect the life of the hose line are possible as the values to be measured. These are primarily the pressure and the temperature of the medium which is located in the hose line and loads its wall. The medium often loads the hose line with pulses as well, the size and frequency of which are decisive for the magnitude of the stress on the hose line. As a result of these and other stresses, the wall of the hose line yields in the course of time, with the result that strains give rise to bulges, which likewise ought to be detected.

The measuring arrangement according to the invention makes it possible to determine such stresses and also their frequency and intensity. If these are known, the ageing of the hose line can be estimated and a time can be fixed, at which, in an economical way but in good time before the hose line bursts as well, replacement is necessary. In this connection, the stresses can, because of the wireless data transmission, be detected even in confined areas, areas of difficult access or dangerous areas as well as on those hose lines which change their position during operation. The evaluating unit can be mobile or stationary. Its recordings also make possible subsequent investigation of the causes of many events which have occurred not only in the area of the hose line but also in other places in the installation.

The measuring unit and its individual parts have such small dimensions that it can perfectly well be arranged within the wall of a hose line, for example by being vulcanized in. Moreover, the small dimensions of the measuring unit make it possible to arrange it on the outer surface of the hose line, where it can be protected, for example, by a pushed-on sleeve. The pressures, temperatures, pulses and strains to be measured and detected are transmitted proportionally toward the outer surface of the hose line and can therefore be picked up there as well.

It is advantageous if the transponder is designed as a smart transponder. The measurement data delivered by the sensor(s) is then, until output to the external evaluating unit, not only stored in the transponder and output in the stored form, but the measurement data can then be processed or evaluated in the transponder even before its output. The memory of such a transponder also makes it possible to obtain reliable and relatively long-term information about the hose line concerned in an inexpensive way.

It is still more advantageous if the measuring unit has a separate data memory. With this, still more measurement data can then be stored, so a larger number of sensors can be used. The measurement data can also then be taken at greater time intervals by the evaluating unit.

The measuring unit can furthermore be equipped with at least one battery or accumulator. Such a power source makes possible greater capacity of the whole device, but in particular of the transponder. A greater distance between the measuring unit and the evaluating unit is then also possible.

In addition, the measuring unit can also be equipped with a transducer. Such a transducer converts the signals coming from the sensor(s) in such a way that they can be stored directly either in the memory of the transponder or in the separate data memory.

The invention is explained in greater detail below with reference to an illustrative embodiment shown in the drawing, in which:

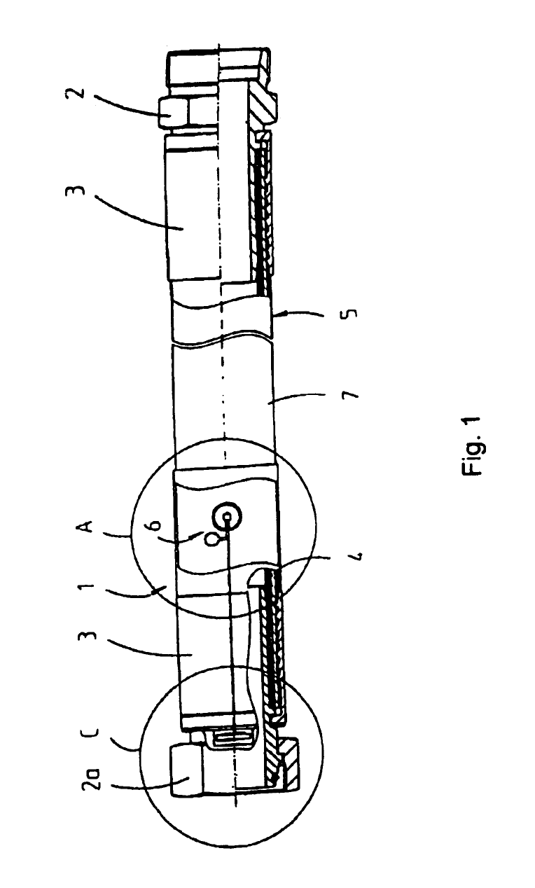

FIG. 1 shows a hose line with a measuring arrangement, partly in longitudinal section;

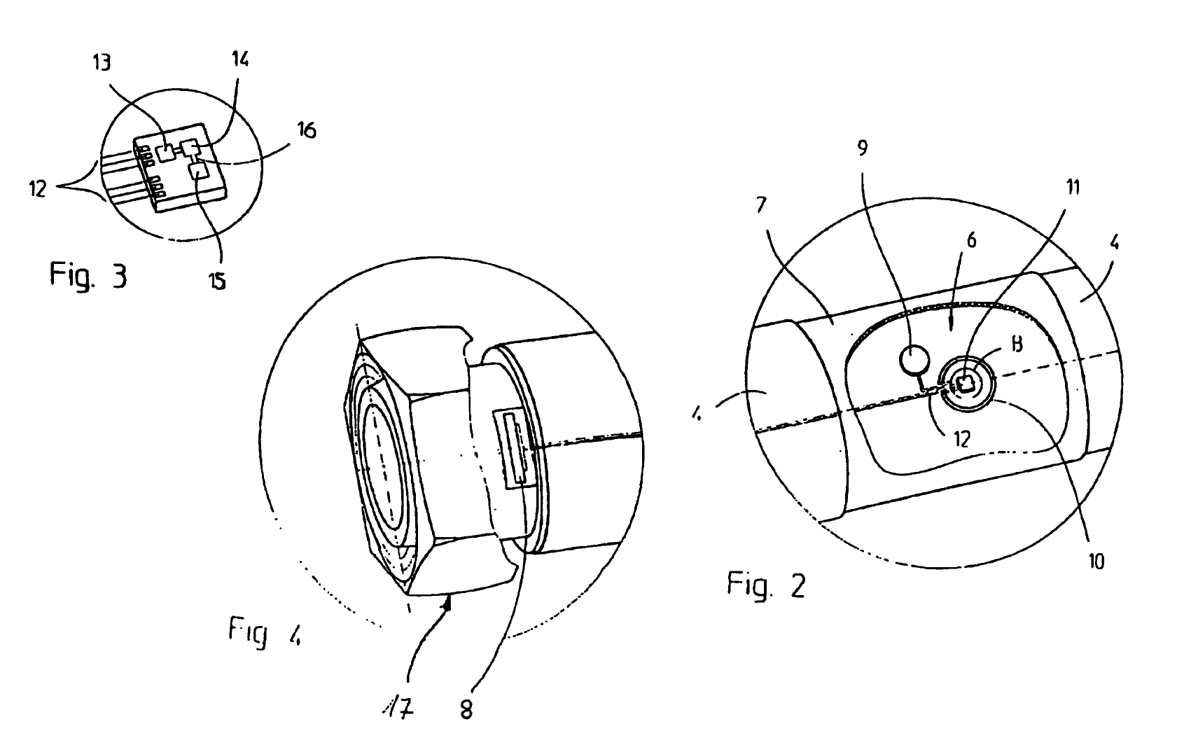

FIG. 2 shows a detail “A” from FIG. 1 diagrammatically and on enlarged scale;

FIG. 3 shows a detail at “B” from FIG. 2 likewise diagrammatically and on further enlarged scale.

A hose line 1 has on each of its two end portions a fitting 2, 2a which, by means of a holder 3, is crimped together mechanically firmly with a hydraulic hose 4 so as to be pressure-medium-tight to the outside. At any location between the two holders 3, a measuring unit 6 is arranged on the outer surface 5 of the hydraulic hose 4 and is connected firmly, for example by gluing, to the outer surface 5. A sleeve 7 pushed over the measuring unit 6 protects it.

The measuring unit 6 illustrated clearly in FIG. 2 has a sensor 8 for, for example, pressure measurement. It is also possible, however, for a number of sensors, and sensors for measuring other values, to be provided. A battery or accumulator 9 provides the measuring unit with power. Also present is a circular antenna 10 for emitting measurement data to an external evaluating unit (not illustrated). Located in the center of the measuring unit 6 is a small board 11, to which connection lines 12 from the sensor 8, the battery 9 and the antenna 10 are led.

FIG. 3 shows the board 11 with the connection lines 12. On the board 11, a smart transponder 13, a data memory 14 and a transducer 15 are arranged and interconnected in the required way via conductors 16 indicated only diagrammatically.

1. A device for measuring pressures, temperatures, pulses, strains and other values in and of hose lines during operation, characterized in that the hose line (1) has at least one measuring unit (6) which has at least one sensor (8) for each measured value, a transponder (13) and an antenna (10) for wireless data transmission to an external evaluating unit.

2. The device as claimed in claim 1, characterized by a smart transponder (13).

3. The device as claimed in one claim 1 or 2, characterized in that the measuring unit (6) has a separate data memory (14).

4. The device as claimed in one claims 1 to 3, characterized in that the measuring unit (6) is equipped with at least one battery or accumulator (9).

5. The device as claimed in one of claims 1 to 4, characterized in that the measuring unit (6) is equipped with a transducer (15).
